(19) United States
(12) Patent Application Publication
(10) Pub. No.: US 2013/0101252 A1
(43) Pub. Date: Apr. 25, 2013

(54) ARRAYED-WAVEGUIDE GRATING HAVING TAILORED THERMAL-SHIFT CHARACTERISTICS AND AN OPTICAL ASSEMBLY EMPLOYING THE SAME

(71) Applicants: Mahmoud S. Rasras, Berkeley Heights, NJ (US); Mark P. Earnshaw, Berkeley Heights, NJ (US)

(72) Inventors: Mahmoud S. Rasras, Berkeley Heights, NJ (US); Mark P. Earnshaw, Berkeley Heights, NJ (US)

(73) Assignee: ALCATEL-LUCENT USA INC., Murray Hill, NJ (US)

(21) Appl. No.: 13/276,360

(22) Filed: Oct. 19, 2011

(51) Int. Cl. G02B 6/293

(52) U.S. Cl. 385/24

(57) ABSTRACT

An arrayed-waveguide grating (AWG) whose thermal-shift characteristics can be tailored to match the corresponding characteristics of another optical device (e.g., a solid-state laser or modulator) to which the AWG is intended to be coupled. In one embodiment, the physical means that enable the match of the thermal-shift characteristics include one or more wedge-shaped structures placed into one or both of the waveguide-coupling regions of the AWG. By appropriately selecting the structure's material, shape, and orientation and also the number of structures, the AWG can be manufactured to have substantially the same thermal-shift coefficient as the other optical device. As a result, the AWG can advantageously remain in optimal spectral alignment with the optical device despite temperature fluctuations and, as such, does not require a thermostat or temperature controller for proper operation.

### BACKGROUND

1. Field of the Invention

The present invention relates to optical communication equipment and, more specifically but not exclusively, to optical multiplexers, de-multiplexers, filters, transmitters, and receivers.

2. Description of the Related Art

This section introduces aspects that may help facilitate a better understanding of the invention(s). Accordingly, the statements of this section are to be read in this light and are not to be understood as admissions about what is in the prior art or what is not in the prior art.

Optical multiplexers and de-multiplexers are widely used in optical wavelength-division multiplexing (WDM) transport systems for combining and separating modulated optical carriers for transmission and detection. An optical multiplexer/de-multiplexer can be implemented, for example, using a silica-based arrayed-waveguide grating (AWG). Such an AWG has been a key device in the commercial deployment of WDM systems, because it is compact and has a relatively low per-unit cost. However, one problem with AWGs is that the spectral positions of their passbands are temperature-dependent, owing mainly to the temperature dependence of the refractive index of silicon oxide and/or other constituent grating materials.

### SUMMARY

Disclosed herein are various embodiments of an arrayed-waveguide grating (AWG) wavelength-selective router whose thermal-shift characteristics can be tailored to match the corresponding characteristics of another optical device (e.g., a solid-state laser or modulator) to which the AWG wavelength-selective router is intended to be coupled. In one embodiment, the physical structures that enable the match of the thermal-shift characteristics include one or more wedge-shaped structures placed into one or both of the star couplers of the AWG wavelength-selective router. By appropriately selecting the structure's material, shape, and orientation and also the number of structures, the AWG wavelength-selective router can be manufactured to have substantially the same thermal-shift coefficient as the other optical device. As a result, the AWG wavelength-selective router can advantageously remain in approximate spectral alignment with the optical device despite temperature fluctuations and, as such, does not require a thermostat or temperature controller for proper operation.

According to one embodiment, provided is an apparatus comprising: an arrayed-waveguide-grating (AWG) wavelength-selective router having a plurality of optical ports; and a second optical device optically coupled to one of the optical ports of the AWG wavelength-selective router. The AWG wavelength-selective router has a passband corresponding to said one optical port whose center wavelength is characterized by a first non-zero thermal-shift coefficient. The second optical device has a characteristic wavelength characterized by a second non-zero thermal-shift coefficient. The first thermal-shift coefficient substantially matches the second thermal-shift coefficient.

According to another embodiment, provided is an apparatus comprising: a first planar star coupler having a first wedge-shaped structure laterally traversing a bulk portion thereof; a second planar star coupler; a first set of one or more waveguides that end-connect to a first surface of the first planar star coupler; a second set of waveguides that connect a second surface of the first planar star coupler to a first surface of the second planar star coupler; and a third set of one or more waveguides that end-connect to a second surface of the second star coupler. The lengths of the waveguides in the second set increase with distance from a first lateral side of the first planar star coupler. The first wedge-shaped structure is oriented to have a wider portion of the structure closer to the first lateral side than a narrower portion of the structure.

### BRIEF DESCRIPTION OF THE DRAWINGS

Other aspects, features, and benefits of various embodiments of the invention will become more fully apparent, by way of example, from the following detailed description and the accompanying drawings, in which:

FIG. 1 shows a block diagram of an optical assembly according to one embodiment of the invention;

FIGS. 2A-2C illustrate an arrayed-waveguide grating (AWG) wavelength-selective router that can be used in the optical assembly of FIG. 1 according to one embodiment of the invention; and

FIGS. 3A-3B graphically show representative characteristics of the AWG wavelength-selective router shown in FIG. 2 according to one embodiment of the invention.

### DETAILED DESCRIPTION

One widely used prior-art approach to dealing with the temperature dependence of arrayed-waveguide gratings (AWGs) is to place them into a temperature-controlled environment, such as a thermostat. However, the incorporation of a thermostat into a system component disadvantageously increases the component's cost. In addition, during operation, the thermostat becomes a significant energy drain due to the continuous heating and/or cooling that it performs, thereby increasing the operating cost of the component.

Another approach to dealing with the temperature dependence of AWGs is to make them athermal, e.g., design an AWG in such a manner that its passbands are temperature-independent within the intended operating-temperature range. However, one drawback of this approach is that other relevant system components need to be athermalized as well, which is not always possible or desirable.

These and other pertinent problems are addressed by certain embodiments, which tailor the thermal-shift characteristics of an AWG to be compatible with the thermal-shift characteristics of other relevant optical components. For example, if an AWG is used in conjunction with a laser whose output wavelength depends on temperature, then the thermal-shift characteristics of the AWG can be tailored to cause the corresponding passband of the AWG to passively (e.g., without external control signals) track the output wavelength of the laser when the operating temperature changes. As further detailed below, various embodiments disclosed herein can advantageously be used, e.g., to provide a low-cost solution for the implementation of coarse WDM (CWDM) transmitters and/or receivers, such as those disclosed in commonly owned U.S. patent application Ser. Nos. 12/944,875, 12/944,939, 12/945,429, 12/944,917, and 12/945,550, filed on Nov. 12, 2010, all of which are incorporated herein by reference in their entirety.

A standardized channel-spacing grid for CWDM is described in Recommendation ITU-T G.694.2, entitled “Spectral Grids for WDM Applications: CWDM Wavelength Grid,” which is incorporated herein by reference in its entirety. The recommended CWDM channels are located in the spectral range between 1271 nm and 1611 nm and have a channel spacing of 20 nm. The IEEE 802.3ae-2002 LX4 physical-layer standard is a representative example of a CWDM system, which standard is incorporated herein by reference in its entirety. In this standard, four wavelengths near 1310 nm, each carrying a 3.125 Gbit/s data stream, are used to carry about 10 Gbit/s of aggregate data. CWDM systems find use in metropolitan applications, cable-television networks, and fiber-to-the-home (FTTH) links.

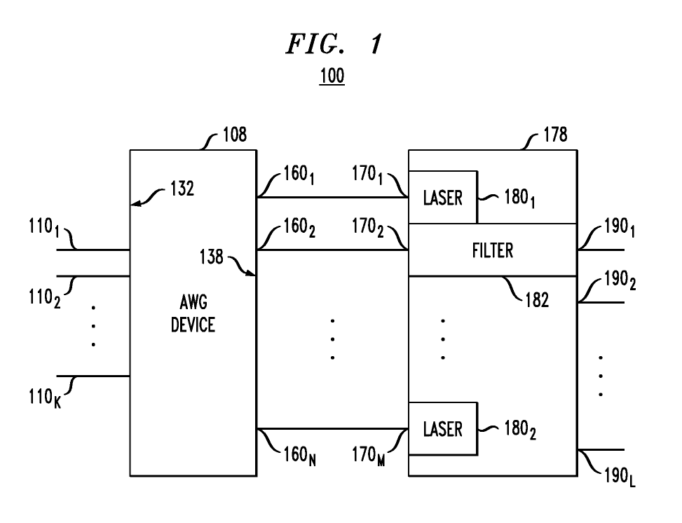

FIG. 1 shows a block diagram of an optical assembly 100 according to one embodiment. Optical assembly 100 comprises an AWG 108 having K optical ports 110 at one side thereof (labeled 132) and N optical ports 160 at the other side thereof (labeled 138), where K and N are positive integers. One or more optical ports 160 of AWG 108 are optically coupled to the corresponding one or more optical ports 170 of a temperature-sensitive (TS) optical device 178. The optical coupling can be implemented by directly connecting the corresponding optical ports to each other (e.g., butt to butt) or via a set of coupling optics (not explicitly shown in FIG. 1). In various embodiments, TS device 178 can include or be, without limitation, one or more lasers, an optical filter (e.g., another AWG), a bank of waveguide-delay lines, an optical switch, an optical mixer, and/or one or more photo-detectors. Depending on the particular embodiment, TS device 178 may or may not have a second set of optical ports 190 optically coupled to optical ports 170 within TS device 178.

Various types of integration can be used to optically couple AWG 108 and TS optical device 178 to one another. For example, hybrid integration can be used, e.g., as disclosed in the above-cited U.S. patent application Ser. Nos. 12/944,875, 12/944,939, 12/945,429, 12/944,917, and 12/945,550. In various embodiments, the optically coupled components of AWG 108 and TS optical device 178 may be characterized by one or more of the following: (i) different respective substrates, (ii) different respective sets of materials, (iii) different respective physical packages, (iv) movable with respect to one another, (v) attached to a common base or board via different respective mounts, and (vi) affixed with respect to one another in a separable manner, e.g., to enable independent repair or replacement.

In a representative embodiment, AWG 108 is a planar lightwave circuit (PLC) designed to operate as a multi-channel optical filter. For example, when a beam of light having spectrum Sᵢₙ(λ) is applied to port 110ₖ (1≦k≦K), it is subjected to optical filtering in AWG 108 so that the filtered light emerging at port 160ₙ (1≦n≦N) has spectrum Sₒᵤₜ(λ) that is described by Eq. (1):

Sₒᵤₜ(λ)=Bₙₖ(λ,T)Sᵢₙ(λ) (1)

where λ is wavelength; Bₙₖ(λ,T) is the transmission spectrum of the corresponding optical channel of the AWG; and T is temperature. Transmission spectrum Bₙₖ(λ,T) does not depend on the light-propagation direction and can be unequivocally specified by providing the optical-port indices n and k. As the notation implies, transmission spectrum Bₙₖ(λ,T) depends on temperature T of AWG 108.

Within the operating-temperature range (e.g., from −5° C. to 70° C. or from −40° C. to 90° C.) for which optical assembly 100 is designed, the temperature dependence of transmission spectrum Bₙₖ(λ,T) can usually be approximated by a linear function. For example, if transmission spectrum Bₙₖ(λ,T) has a spectral shape of a passband, then this passband will shift nearly linearly, without significantly changing its spectral shape, at a constant rate,

$${R}_{1} ( = \frac{δ {λ}_{c}}{δ T} ) ,$$

where λ_{c} is a characteristic wavelength (e.g., a center wavelength) of the passband. Hereafter, this rate or any of its analogues is referred to as a thermal-shift coefficient. A thermal-shift coefficient can be measured, e.g., in nm/Kelvin or Hz/Kelvin.

Similar to AWG 108, TS device 178 has temperature-dependent spectral characteristics. For example, if TS device 178 includes a solid-state laser 180 made of III-V materials, then the temperature dependence of the refractive indices of those materials causes the output wavelength generated by the laser to change with temperature. If TS device 178 includes an optical filter 182, then the transmission spectrum of the filter may shift with temperature in a manner that is qualitatively similar to that of AWG 108. Pertinent spectral characteristics of other types of optical devices can similarly be characterized by some characteristic wavelength or frequency. In general, within a typical operating-temperature range, the temperature dependence of TS device 178 is approximately linear and can be characterized by thermal-shift coefficient

$${R}_{2} ( = \frac{δ {λ}_{d}}{δ T} ) ,$$

where λ_{d} is a characteristic wavelength of the TS device. Depending on the particular type of TS device 178, characteristic wavelength λ_{d} can be an emission wavelength, a center wavelength of a spectral band, or any other wavelength that can be used to quantify the temperature dependence of the TS device.

In a representative embodiment, optical assembly 100 is designed so that it can operate properly without active temperature control and, as such, does not have a thermostat and/or a temperature controller for actively controlling the temperature(s) of AWG 108 and TS device 178. As a result, the temperature of AWG 108 and TS device 178 is about the same as the ambient temperature or tracks the ambient temperature relatively closely if there is a heat source/sink within or near optical assembly 100. The proper operation of optical assembly 100 is achieved by manufacturing AWG 108 so that its thermal-shift coefficient R₁ matches the thermal-shift coefficient R₂ of TS device 178.

As used herein, the term “match” or “substantially match” means that thermal-shift coefficients R₁ and R₂ differ from one another by no more than about 10%, with the larger of the two coefficients being assigned the 100% value. In various alternative embodiments, thermal-shift coefficients R₁ and R₂ may differ from one another by no more than 5%, or even by no more than 1% within the intended operating-temperature range of assembly 100.

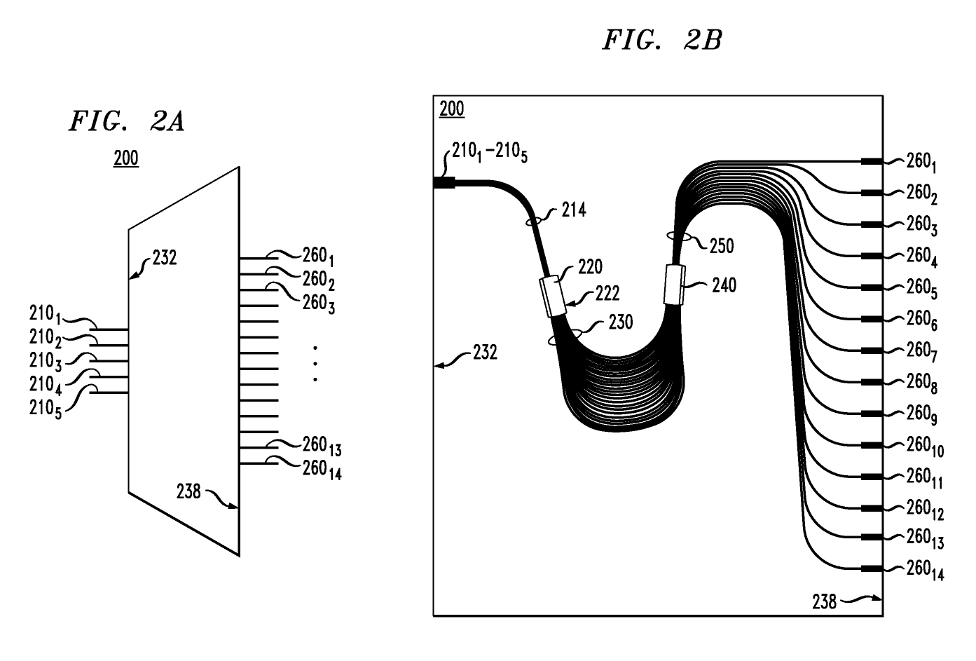

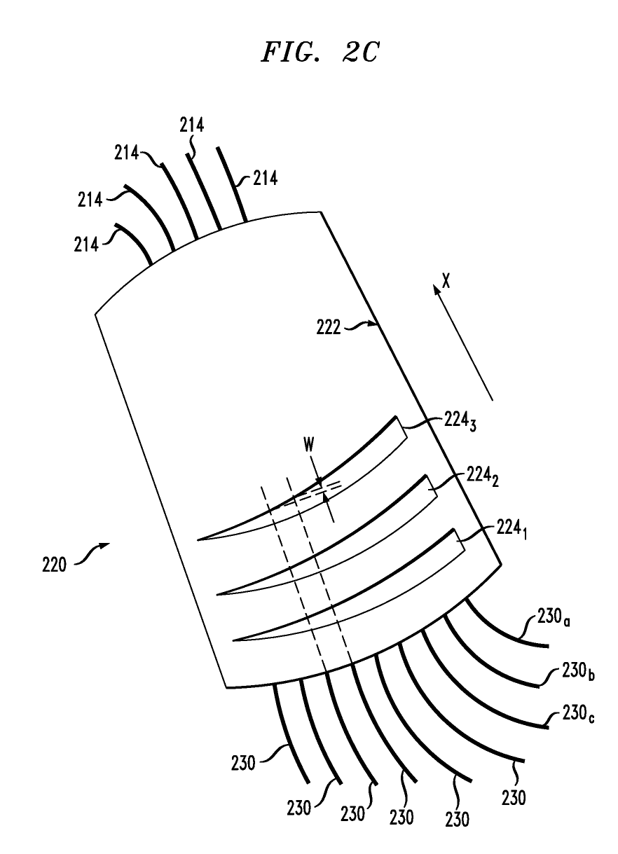

For example, when a temperature change causes the output wavelength generated by laser 180 to shift from wavelength λ₁ at temperature T₁ to wavelength λ₂ at temperature T₂, the corresponding passband of AWG 108 will passively track this shift because thermal-shift coefficients R₁ and R₂ are matched to one another. When AWG 108 and laser 180 are used to implement a CWDM transmitter, the transmitter typically operates in an optimal manner when the AWG channel configured to receive light from laser 180 has its center wavelength aligned with the output wavelength of the laser. Thus, if the center wavelength of the corresponding passband is near λ₁ at temperature T₁, then the center wavelength will be near λ₂ at temperature T₂, thereby enabling the transmitter to advantageously remain in an optimal configuration despite the temperature change. A representative embodiment of the physical means that enable AWG 108 to passively track thermal fluctuations of TS device 178 are described in more detail below in reference to FIG. 2.

FIGS. 2A-2C illustrate an AWG wavelength-selective router 200 that can be used as AWG 108 according to one embodiment of the invention. More specifically, FIG. 2A shows a block diagram of AWG wavelength-selective router 200. FIG. 2B shows a top view of AWG wavelength-selective router 200. FIG. 2C shows an enlarged top view of a waveguide-coupler region (planar optical star coupler) 220 in AWG wavelength-selective router 200.

Passive AWG router 200 has, e.g., five optical ports 210₁-210₅ at its first side or edge (labeled 232) and, e.g., fourteen optical ports 260₁-260₁₄ at its second side or edge (labeled 238). Sides 232 and 238 of AWG wavelength-selective router 200 correspond to edges 132 and 138, respectively, of AWG 108 (FIG. 1). Optical ports 210₁-210₅ are arranged in a linear array, in which neighboring ports may be equidistant from one another. Optical ports 260₁-260₁₄ are arranged in an analogous linear array. Optical ports 210₁-210₅ may be relatively tightly packed together, whereas optical ports 260₁-260₁₄ may be relatively more widely spread out.

Passive AWG router 200 has planar optical star couplers (also sometimes referred to as slabs) 220 and 240. Coupler 220 is optically connected to optical ports 210₁-210₅ via five respective waveguides 214. Coupler 240 is similarly connected to optical ports 260₁-260₁₄ via fourteen respective waveguides 250. Couplers 220 and 240 are also connected to one another via a plurality of waveguides 230. Different waveguides 230 have different respective lengths, with the lengths increasing as the distance between the proximate end of waveguide 230 and an edge 222 of coupler 220 increases. For example, waveguide 230ₐ has a shorter length than waveguide 230_{b} because the proximate end of waveguide 230ₐ is closer to edge 222 than the proximate end of waveguide 230_{b} (see FIG. 2C). Similarly, waveguide 230_{b} has a shorter length than waveguide 230_{c} because the proximate end of waveguide 230_{b} is closer to edge 222 than the proximate end of waveguide 230_{c}, etc. The length difference between 230ₐ and 230_{b} is equal to the length difference between 230_{b} and 230_{c}. This relationship is true for all adjacent waveguides in the plurality of waveguides 230.

In one embodiment, the cores of waveguides 230, the cores of waveguides 214, and most of the body of coupler 220 are made of the same material, which has a higher refractive index than the cladding material around the cores and the coupler. A representative core material is doped silicon oxide. As known in the art, the refractive index of silicon oxide increases with temperature. Coupler 220 also has a plurality of wedge-shaped structures 224 that can be formed, e.g., by removing the core material from the body of coupler 220 and filling up the resulting wedge-shaped trenches with a different material, e.g., a material whose index of refraction decreases with temperature. A representative example of such a material is a silicone resin.

Coupler 220 is illustratively shown in FIG. 2C as having three wedge-shaped structures 224. In general, coupler 220 may have one or more wedge-shaped structures 224. Note that the width (i.e., the X or transverse dimension) of structure 224 increases approximately linearly in the direction toward edge 222. In one embodiment, the wedge-width increase over a distance corresponding to the distance between the ends of two adjacent waveguides 230 is a constant w defined by Eq. (3). This particular configuration of structures 224, if they are made of a silicone resin, results in a larger value of thermal-shift coefficient R₁ for AWG wavelength-selective router 200 than a hypothetical value R₀ that the AWG wavelength-selective router would have without the wedge-shaped structures. The extent of the increase depends on the shape (e.g., the value of w) of the wedge and the number of structures 224. Therefore, these and other relevant parameters of structures 224 can be selected at the design stage to achieve a desired value of thermal-shift coefficient R₁ for AWG wavelength-selective router 200.

Suppose now that AWG wavelength-selective router 200 needs to be coupled to TS device 178 whose thermal-shift coefficient R₂ is greater than R₀. Then one can choose a suitable (e.g., polymeric) material whose refractive index decreases with temperature and then select a suitable number of and shapes for individual structures 224 to cause an increase in the effective thermal-shift coefficient and obtain R₁≈R₂.

The shapes of structures 224 are typically in conformity with the AWG interference condition, which can be expressed, e.g., using Eq. (2):

w(nₚ−nₚ)+nₐΔL=mλ_{c} (2)

where w is the wedge-width change near the middle portion of coupler 220 over a distance corresponding to the distance between the ends of two adjacent waveguides 230 (also see FIG. 2C, structure 224₃, for which the geometric meaning of w is indicated); nₚ is the refractive index of the structure material; n_{b} is the refractive index of the coupler-body material; nₐ is the effective refractive index of waveguide 230 of the AWG; ΔL is the length increment between two adjacent waveguides 230 of the AWG; m is an integer; and λ_{c} is the center wavelength of the corresponding passband of the AWG. Note that nₐ and n_{b} differ from one another because the light travelling in waveguide 230 resides both in the core and the cladding while the light travelling across coupler 220 is substantially confined within the body of the coupler.

Note also that Eq. (2) and the subsequent equations that rely on Eq. (2) provide an approximation because Eq. (2) uses width increment was an approximate substitute for a more accurate geometric parameter that would emerge, e.g., from a detailed optical-ray tracing analysis of the geometry of coupler 220. One of ordinary skill in the art will be able to use the physical principles expressed by Eq. (2) to perform appropriate numerical simulations that more accurately relate the parameters of structures 224 and thermal-shift coefficient R₁. Such numerical simulations can be used to guide the design process and determine the desired geometric shapes of structures 224 that preserve the intended wavelength-routing relationship between waveguides 214 and 230 while enabling AWG wavelength-selective router 200 to attain a target value of thermal-shift coefficient R₁.

By taking a derivative over temperature of both sides of Eq. (2) and making appropriate rearrangements and substitutions, one arrives at Eq. (3):

$$w = \frac{- B Δ L + {n}_{a} \frac{Δ L}{{λ}_{c}} {R}_{2}}{A - {R}_{2} \frac{( {n}_{p} - {n}_{b} )}{{λ}_{c}}} \qquad ( 3 )$$

where parameters A and B are given by Eqs. (4a) and (4b):

$$\begin{matrix}A = \frac{d {n}_{p}}{d T} - \frac{d {n}_{b}}{d T} + α ( {n}_{p} - {n}_{b} ) & ( 4 a ) \\ B = \frac{d {n}_{a}}{d T} - \frac{α {n}_{b}}{Δ L} & ( 4 b )\end{matrix}$$

where α is the thermal expansion coefficient of waveguide 230.

Note that the derivation of Eq. (3) did not rely on the initial premise that the material of structure 224 has a refractive index that decreases with temperature (i.e.,

$$\frac{d {n}_{p}}{d T} < 0 ) ,$$

which means that Eq. (3) is also applicable to other structure materials. One of ordinary skill in the art will appreciate that the material selection for structures 224 is primarily governed by the values of R₀ and R₂. For example, if R₀<R₂, then a structure material with a negative

$$\frac{d {n}_{p}}{d T}$$

may be selected. On the other hand, if R₀>R₂, then a structure material with a positive

$$\frac{d {n}_{p}}{d T}$$

may be selected, wherein

$$\frac{d {n}_{p}}{d T} > \frac{d {n}_{b}}{d T} .$$

Moreover, the wedge orientation is not necessarily limited to that indicated in FIG. 2C, and an opposite wedge orientation in which the width of structure 224 decreases in the direction toward edge 222 may alternatively be used. With the latter wedge orientation, if R₀>R₂, then a structure material with a negative

$$\frac{d {n}_{p}}{d T}$$

may be selected. On the other hand, if R₀<R₂, then an structure material with a positive

$$\frac{d {n}_{p}}{d T}$$

may be selected, wherein

$$\frac{d {n}_{p}}{d T} > \frac{d {n}_{b}}{d T} .$$

Other suitable combinations of the wedge orientation and the relative values of

$$\frac{d {n}_{p}}{d T} and \frac{d {n}_{b}}{d T}$$

are also possible and fall within the scope of this specification.

In one embodiment, coupler 240 (FIG. 2B) can have wedge-shaped structures that are analogous to structures 224 (FIG. 2C). The respective orientations of wedge-shaped structures in couplers 220 and 240 may be the same or different. Embodiments in which only coupler 240 (but not coupler 220) has wedge-shaped structures are also contemplated, and vice versa.

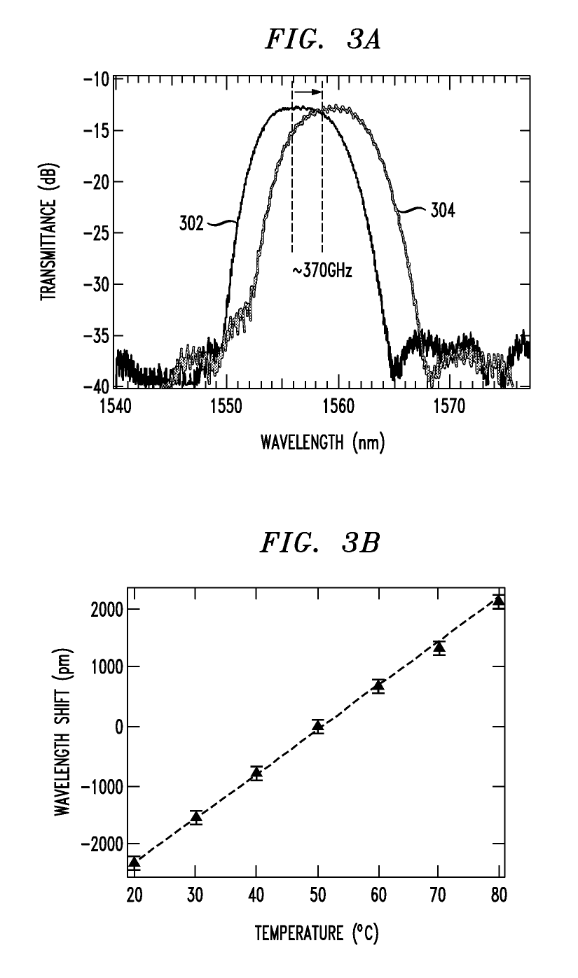

FIGS. 3A-3B graphically show representative characteristics of an AWG wavelength-selective router 200 according to one embodiment. More specifically, FIG. 3A graphically shows the spectral shape of one selected passband of AWG wavelength-selective router 200. FIG. 3B graphically shows the shift of the center wavelength of the passband shown in FIG. 3A as a function of temperature, with the reference temperature being 50° C. The embodiment of AWG wavelength-selective router 200 illustrated by FIGS. 3A-3B has a single optical port 210 and is designed to have a 20-nm inter-channel spacing compatible with CWDM specifications.

FIG. 3A shows two transmission spectra 302 and 304 corresponding to the selected optical channel of AWG wavelength-selective router 200. Spectrum 302 was measured at 32.5° C. Spectrum 304 was similarly measured at 70° C. As can be seen, the temperature increase resulted in a red shift of the channel's passband by about 370 GHz.

FIG. 3B shows that the experimentally measured temperature-induced passband shift (triangles) is modeled well by a linear function (dashed line). The slope of the dashed line gives a value of thermal-shift coefficient R₁ of about 74 pm/Kelvin. For comparison, in the absence of structures 224, the same AWG wavelength-selective router would have a thermal-shift coefficient (R₀) of about 11 pm/Kelvin.

While these inventions have been described with reference to illustrative embodiments, this description is not intended to be construed in a limiting sense.

For examples, in some embodiments and/or applications of assembly 100 (FIG. 1), light flows from right to left in FIG. 1, while, in other embodiments and/or applications, light flows from left to right.

Various modifications of the described embodiments, as well as other embodiments of the invention, which are apparent to persons skilled in the art to which the invention pertains are deemed to lie within the principle and scope of the invention as expressed in the following claims.

For the purposes of this specification, a thermal-shift coefficient should be considered non-zero when its absolute value is greater than about 0.5 pm/Kelvin.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The use of terms such as height, length, width, top, bottom, is strictly to facilitate the description of the invention and is not intended to limit the invention to a specific orientation. For example, height does not imply only a vertical rise limitation, but is used to identify one of the three dimensions of a three-dimensional structure as shown in the figures. Such “height” would be vertical where the electrodes are horizontal but would be horizontal where the electrodes are vertical, and so on.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term compatible means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

The description and drawings merely illustrate the principles of the invention. It will thus be appreciated that those of ordinary skill in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

What is claimed is:

1. An apparatus, comprising:
an arrayed-waveguide-grating (AWG) wavelength-selective router having a plurality of optical ports; and
a second optical device optically coupled to one of the optical ports of the AWG wavelength-selective router, wherein:
the AWG wavelength-selective router has a passband corresponding to said optical port whose center wavelength is characterized by a first non-zero thermal-shift coefficient;
the second optical device has a characteristic wavelength characterized by a second non-zero thermal-shift coefficient; and
the first thermal-shift coefficient substantially matches the second thermal-shift coefficient.

2. The apparatus of claim 1, wherein the first thermal-shift coefficient differs from the second thermal-shift coefficient by no more than about 5%.

3. The apparatus of claim 1, wherein:
the second optical device comprises a laser source; and
the characteristic wavelength is an output wavelength of the laser source.

4. The apparatus of claim 3, wherein the AWG wavelength-selective router and the second optical device are parts of a coarse wavelength-division-multiplexing (CWDM) transmitter.

5. The apparatus of claim 1, wherein:
the second optical device comprises an optical filter; and
the characteristic wavelength is a center wavelength of a corresponding spectral band of the optical filter.

6. The apparatus of claim 1, wherein the AWG wavelength-selective router comprises:
a first planar star coupler having one or more wedge-shaped structures, each having a refractive index that is different from a refractive index of a bulk portion of the first planar star coupler.

7. The apparatus of claim 6, wherein:
at least one of the one or more wedge-shaped structures comprises a polymer; and
the bulk portion of the first planar star coupler comprises an inorganic glass or semiconductor.

8. The apparatus of claim 7, wherein:
the polymer is a silicone; and
the bulk portion includes doped silicon oxide.

9. The apparatus of claim 7, wherein:
the polymer has a refractive index that decreases with temperature increase within an operating temperature range of the AWG wavelength-selective router; and
the bulk portion has a refractive index that increases with temperature increase within the operating temperature range of the AWG wavelength-selective router.

10. The apparatus of claim 6, wherein the AWG wavelength-selective router further comprises:
a second planar star coupler;
a first set of one or more waveguides that connect a first set of optical ports and the first planar star coupler;
a second set of waveguides that connect the first planar star coupler and the second planar star coupler; and
a third set of one or more waveguides that connect the second planar star coupler and a second set of optical ports.

11. The apparatus of claim 10, wherein:
the waveguides in the second set have different respective lengths, with the waveguide lengths increasing as a distance from a proximate end of the corresponding waveguide to a first side of the first coupler increases; and
the one or more wedge-shaped structures are oriented to have a wider portion of the structure closer to the first side than a narrower portion of the structure.

12. The apparatus of claim 10, wherein the second planar star coupler comprises:
a bulk portion; and
one or more wedge-shaped structures located within said bulk portion.

13. An apparatus, comprising:
a first planar star coupler having a first wedge-shaped structure laterally traversing a bulk portion thereof;
a second planar star coupler;
a first set of one or more waveguides that end-connect to a first surface of the first planar star coupler;
a second set of waveguides that connect a second surface of the first planar star coupler to a first surface of the second planar star coupler; and
a third set of one or more waveguides that end-connect to a second surface of the second star coupler, wherein:
lengths of the waveguides in the second set increase with distance from a first lateral side of the first planar star coupler; and
the first wedge-shaped structure is oriented to have a wider portion of the structure closer to the first lateral side than a narrower portion of the structure.

14. The apparatus of claim 13, wherein:
the first planar star coupler further has one or more additional wedge-shaped structure laterally traversing the bulk portion thereof; and
each of the one or more additional wedge-shaped structures is oriented to have a wider portion of the structure closer to the first lateral side than a narrower portion of the structure.

15. The apparatus of claim 13, wherein:
the first wedge-shaped structure comprises a material having a refractive index that is different from a refractive index of the bulk portion of the first planar star coupler.

16. The apparatus of claim 15, wherein:
said material includes a silicone; and
the bulk portion includes silicon oxide.

17. The apparatus of claim 15, wherein:
the refractive index of said material decreases as temperature increases; and
the refractive index of the bulk portion increases as temperature increases.

18. The apparatus of claim 13, wherein the second planar star coupler comprises a wedge-shaped structure that laterally traverses a portion thereof.

19. The apparatus of claim 13, further comprising a laser source optically coupled to transmit light through a waveguide of the first set or a waveguide of the third set.

20. The apparatus of claim 19, wherein:
the first planar star coupler is part of an AWG wavelength-selective router; and
the laser and a corresponding passband of the AWG wavelength-selective router have respective characteristic wavelengths that are characterized by substantially equal thermal-shift coefficients.
